(19) United States
(12) Patent Application Publication
(10) Pub. No.: US 2018/0127952 A1
(43) Pub. Date: May 10, 2018

(54) EXCAVATOR BUCKET WITH INTEGRATED RADAR SYSTEM

(71) Applicant: Caterpillar Inc., Peoria, IL (US)

(72) Inventors: Alessandro Magliulo, Morrisville, NC (US); William Shea Gibson, Smithfield, NC (US)

(73) Assignee: Caterpillar Inc., Peoria, IL (US)

(21) Appl. No.: 15/344,896

(22) Filed: Nov. 7, 2016

(51) Int. Cl. E02F 9/26; E02F 3/40; E02F 3/28; G01S 13/88

(52) U.S. Cl. CPC E02F 9/261; E02F 3/40; E02F 3/32; G01S 13/885; E02F 3/28

(57) ABSTRACT

A bucket associated with a machine is provided. The bucket includes an integrated RADAR system. The bucket also includes a first compartment provided at a first section of the bucket. The first compartment defining a cavity. A control module of the RADAR system is mounted within the cavity of the first compartment. The bucket further includes a second compartment provided at a second section of the bucket. The second section is opposite to the first section. A sensor module of the RADAR system is mounted within the second compartment. The sensor module is configured to scan and penetrate a ground surface proximate to the bucket. The bucket includes a channel extending between the first compartment and the second compartment. The channel is adapted to house wires that communicably couple the sensor module with the control module.

### TECHNICAL FIELD

The present disclosure relates to an implement for a machine such as a bucket, and more particularly to the bucket having an integrated RADAR system.

### BACKGROUND

A machine, such as an excavator or a backhoe loader, is used for digging and removing material from grounds and similar surfaces. The machine includes an implement, such as, a bucket. During a digging operation, the bucket is lowered into the ground for digging purposes. There is a need to detect objects or obstacles, i.e. sewer, pipes, man holes, cables, etc., so that contact of the bucket with these objects may be avoided. Since these objects may sometimes lie below the ground, it may be difficult to observe these objects. Hence, during operation, the bucket may contact or impact these objects, which is undesirable.

Accordingly, a ground penetrating RADAR system may be associated with the bucket for detection of these underground objects. However, mounting of various components of the RADAR system may be difficult due to space constraints and design of the bucket.

U.S. Pat. No. 4,006,481 describes an apparatus for detecting the presence of a buried, hidden object in the vicinity of a digging tool in order to prevent a human disaster and damage to utility lines or other buried structures. The apparatus includes an impulse generator and data processing means connected to a slot antenna formed in the tool of an earthmoving machine for radiating a burst of broad spectrum electromagnetic energy into the ground and for receiving and data processing reflected electromagnetic echoes. One antenna embodying the invention comprises a slot formed through a wall of a hydraulically driven shovel and filled with a ceramic absorber. The slot has four radially extending, orthogonally arranged loops having unclosed central portions of the loops joined end to end to form four apexes.

### SUMMARY OF THE DISCLOSURE

In one aspect of the present disclosure, a bucket associated with a machine is provided. The bucket includes an integrated RADAR system. The bucket also includes a first compartment provided at a first section of the bucket. The first compartment defines a cavity. A control module of the RADAR system is mounted within the cavity of the first compartment. The bucket further includes a second compartment provided at a second section of the bucket. The second section is opposite to the first section. A sensor module of the RADAR system is mounted within the second compartment. The sensor module is configured to scan and penetrate a ground surface proximate to the bucket. The bucket includes a channel extending between the first compartment and the second compartment. The channel is adapted to house wires that communicably couple the sensor module with the control module.

In another aspect of the present disclosure, a machine is provided. The machine includes a machine body. The machine also a bucket pivotably coupled to the machine body. The bucket includes an integrated RADAR system. The bucket also includes a first compartment provided at a first section of the bucket. The first compartment defines a cavity. A control module of the RADAR system is mounted within the cavity of the first compartment. The bucket further includes a second compartment provided at a second section of the bucket. The second section is opposite to the first section. A sensor module of the RADAR system is mounted within the second compartment. The sensor module is configured to scan and penetrate a ground surface proximate to the bucket. The bucket includes a channel extending between the first compartment and the second compartment. The channel is adapted to house wires that communicably couple the sensor module with the control module.

In yet another aspect of the present disclosure, a ground penetration system for a machine is provided. The ground penetration system includes a RADAR system. The RADAR system includes a control module and a sensor module. The ground penetration system also includes a bucket adapted to perform a digging operation of the machine. The bucket includes a first compartment provided at a first section of the bucket. The first compartment defines a cavity. The bucket also includes a second compartment provided at a second section of the bucket. The second section is opposite to the first section. The bucket further includes a channel extending between the first compartment and the second compartment. Further, the control module and the sensor module of the RADAR system are positioned within the first and second compartments of the bucket, respectively, and are electrically connected to each other by electrical wires housed within the channel for scanning and penetrating a ground surface proximate to the bucket.

Other features and aspects of this disclosure will be apparent from the following description and the accompanying drawings.

### BRIEF DESCRIPTION OF THE DRAWINGS

FIG. 1 is a perspective view of an exemplary machine, according to various concepts of the present disclosure;

FIG. 2 is a perspective view of an interior of a bucket of the machine of FIG. 1, according to various concepts of the present disclosure;

FIG. 3 is an exploded view of a first compartment of the bucket of FIG. 2, according to various concepts of the present disclosure;

FIG. 4 is an exploded view of a second cover plate of the bucket of FIG. 2, according to various concepts of the present disclosure;

FIG. 5 is a side view of the second cover plate of the bucket of FIG. 2, according to various concepts of the present disclosure; and

FIG. 6 is a perspective view of the bucket of the machine of FIG. 1, the bucket having a pair of channels, according to various concepts of the present disclosure.

### DETAILED DESCRIPTION

Wherever possible, the same reference numbers will be used throughout the drawings to refer to the same or the like parts. Also, corresponding or similar reference numbers will be used throughout the drawings to refer to the same or corresponding parts.

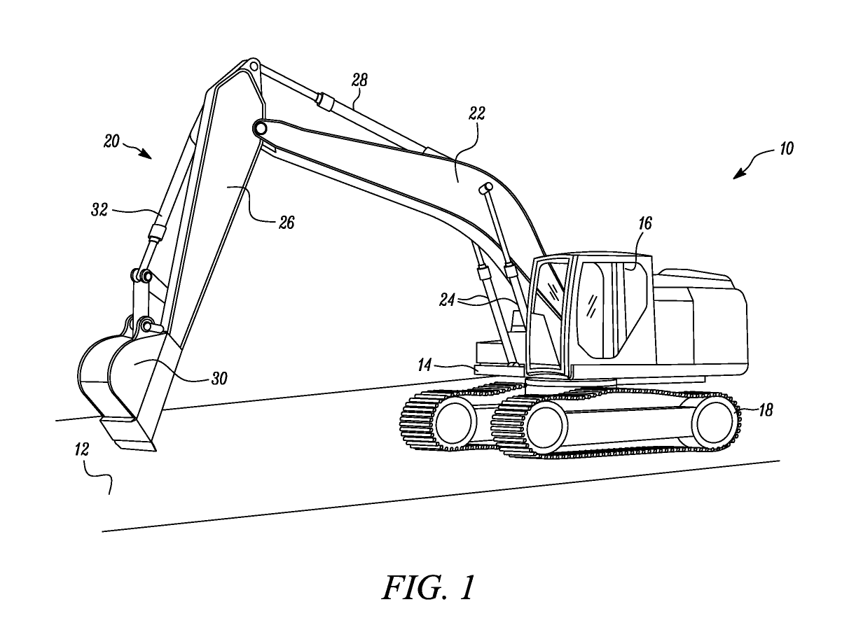

Referring to FIG. 1, an exemplary machine 10 is illustrated. The machine 10 is an excavator, and operates on a ground surface 12. Alternatively, the machine 10 may include, but is not limited to, a wheel loader, a backhoe loader, a shovel, a track type tractor, a skid steer loader, etc., without any limitations. The machine 10 may be associated with an industry including, but not limited to, construction and material handling.

The machine 10 includes a machine body 14, hereinafter interchangeably referred to as body 14. Further, an operator cabin 16 is positioned on the body 14. An operator seated in the operator cabin 16 may control an operation of the machine 10. The machine 10 includes tracks 18. The tracks 18 are embodied as ground engaging members that allow movement of the machine 10 on the ground surface 12. In an alternate example, the machine 10 may include wheels for movement of the machine 10, without any limitations.

Further, the machine 10 includes a linkage assembly 20 coupled to the body 14. The linkage assembly 20 includes a boom 22 which is pivotally coupled to the body 14. A pair of hydraulic cylinders 24 controlled by the operator sitting in the operator cabin 16 or a machine control unit (not shown) that is present onboard the machine 10 moves the boom 22 relative to the body 14 during machine operation. The machine control unit is hereinafter referred to as MCU. Alternatively, the machine 10 may include a single hydraulic cylinder that causes movement of the boom 22 relative to the body 14 based on commands received from the operator or the MCU.

Also, a stick 26 is pivotally coupled to the boom 22 such that the stick 26 can swing to-and-from relative to the boom 22. A hydraulic cylinder 28 moves the stick 26 relative to the boom 22. Further, a bucket 30 is pivotally coupled to the stick 26 for performing a digging operation. A hydraulic cylinder 32 moves the bucket 30 relative to the stick 26.

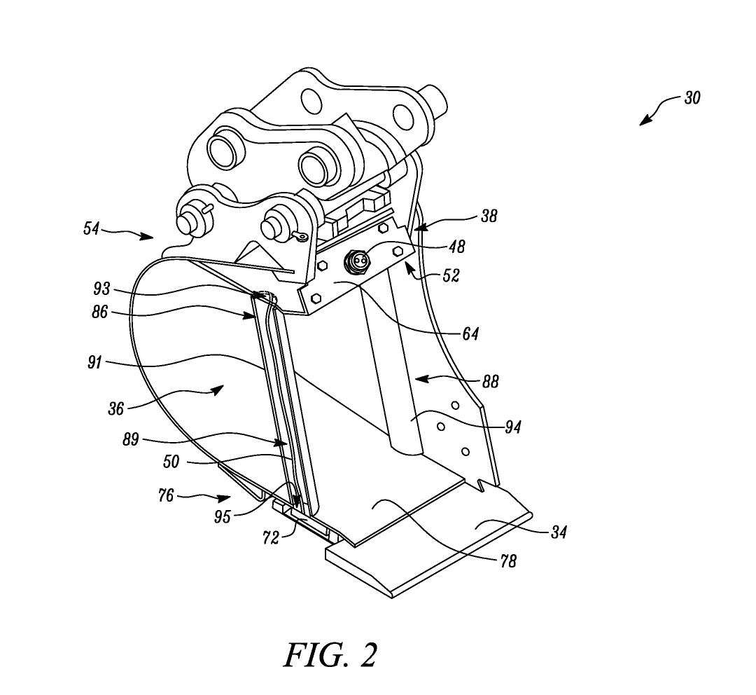

Referring to FIG. 2, the bucket 30 includes a blade 34 that contact the ground surface 12 for digging purposes. In an alternate example, the bucket 30 may include a number of teeth instead of the blade 34. Further, the bucket 30 includes a material holding section 36 for holding material that is removed from grounds during the digging operation. Dimensions and shape of the bucket 30 associated with the machine 10 may vary based on a type and size of the machine 10, without any limitations.

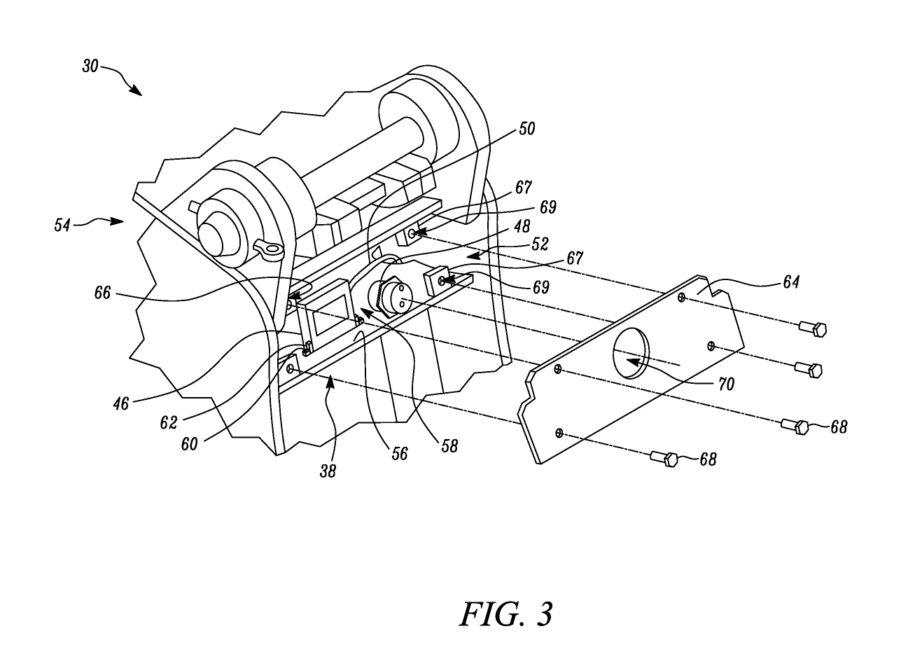

Referring to FIG. 3, the bucket 30 includes a first compartment 52. The first compartment 52 is provided at a first section 54 of the bucket 30. The first compartment 52 includes a base member 56. Further, the first compartment 52 defines a cavity 58. A control module 46 is mounted within the cavity 58. The control module 46 forms a part of an integrated RADAR system 38. The RADAR system 38 referred to herein is embodied as an object detection system that detects presence of objects present beneath the ground surface 12. The object may include sewer pipes, electric cables, man holes, etc. extending beneath the ground surface 12.

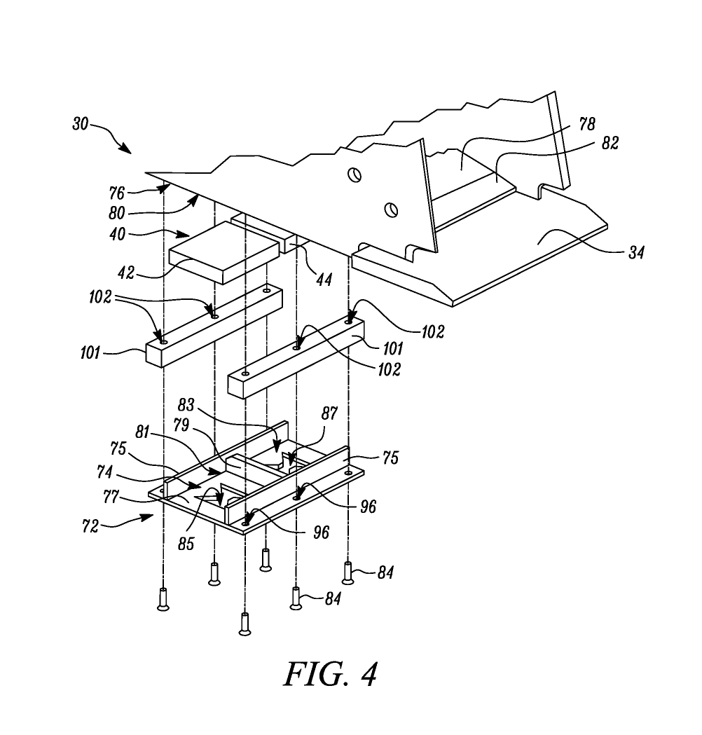

Further, the control module 46 receives a signal indicative of the presence of the object from a sensor module 40 (see FIG. 4). The control module 46 is communicably coupled with the sensor module 40. Based on receipt of the signal indicative of the presence of the object from the sensor module 40, the control module 46 transmits data pertaining to the presence of the object to the MCU and/or the user interface to alert the operator regarding the presence of the object.

In the illustrated example, the control module 46 is coupled to the base member 56 using mechanical fasteners 60. More particularly, mounting members 62 of the control module 46 of the control module 46 couples with the base member 56 using the mechanical fasteners 60. The mechanical fasteners 60 may embody any one of a bolt or a screw, without any limitations. In an alternate example, the mounting members 62 may be coupled to the base member 56 by welding, brazing, soldering, or any other coupling means known in the art.

The first compartment 52 also includes a first cover plate 64. The first cover plate 64 encloses the cavity 58 of the first compartment 52. A shape of the first cover plate 64 corresponds to a shape of an opening 66 defined by the first compartment 52. The opening 66 includes a number of spacers 67. Each of the spacers 67 include a threaded opening 69. In the illustrated example, the first cover plate 64 is overlaid on the opening 66 and fastened to the threaded openings 69 of the respective spacer 67 using mechanical fasteners 68. The mechanical fasteners 68 may embody any one of a bolt or a screw, without any limitations. In an alternate example, the first cover plate 64 may be coupled to the opening 66 by welding, brazing, soldering, or any other coupling means known in the art.

Further, an aperture 70 is defined in the first cover plate 64. An electrical connector 48 is received in the aperture 70. In the illustrated example, the electrical connector 48 of the RADAR system 38 establishes a wired connection between the control module 46 and the machine 10. Further, a wire 50 establishes electrical connection between the control module 46 and the sensor module 40.

As shown in FIG. 2, when the electrical connector 48 is coupled to the first cover plate 64, a portion of the electrical connector 48 protrudes from an outer surface of the first cover plate 64. In one example, the electrical connector 48 may be threadably received within the aperture 70 of the first cover plate 64.

Referring now to FIG. 4, a second cover plate 72 is coupled to the bucket 30. The second cover plate 72 defines a second compartment 74. The sensor module 40 of the RADAR system 38 is mounted within the second compartment 74. More particularly, each of a transmitter 42 and a receiver 44 of the sensor module 40 is mounted within the second compartment 74. The second compartment 74 is defined by a pair of first vertical plates 75 extending from a base 77 of the second cover plate 72. Further, a second vertical plate 79 divides the second compartment 74 in two portions 81, 83, each of which receive the transmitter and receiver 42, 44, respectively. In an alternate example, the second vertical plate 79 may be omitted such that second compartment 74 defines a single opening to receive a unitary transmitting and receiving unit. In such an example, the transmitter and the receiver of the sensing module 40 may be incorporated in the unitary unit. Further, the base 77 includes a number of through holes 96.

Each of the portions 81, 83 include openings 85, 87 defined therein. The openings 85, 87 allow transmission and receipt of signals by the sensor module 40. The second cover plate 72 also includes a pair of spacers 101 associated therewith. The pair of spacers 101 allow coupling of the second cover plate 72 with a floor 78 of the bucket 30, and bridges a gap defined by the base 77 and the first vertical plates 75. When the second cover plate 72 is coupled with the floor 78, the spacers 101 are held between the floor 78 and the base 77 of the second cover plate 72. The spacers 101 include a number of through holes 102. Alternatively, the spacers 101 can be coupled with the floor 78 by welding, brazing, soldering, or any other coupling means known in the art.

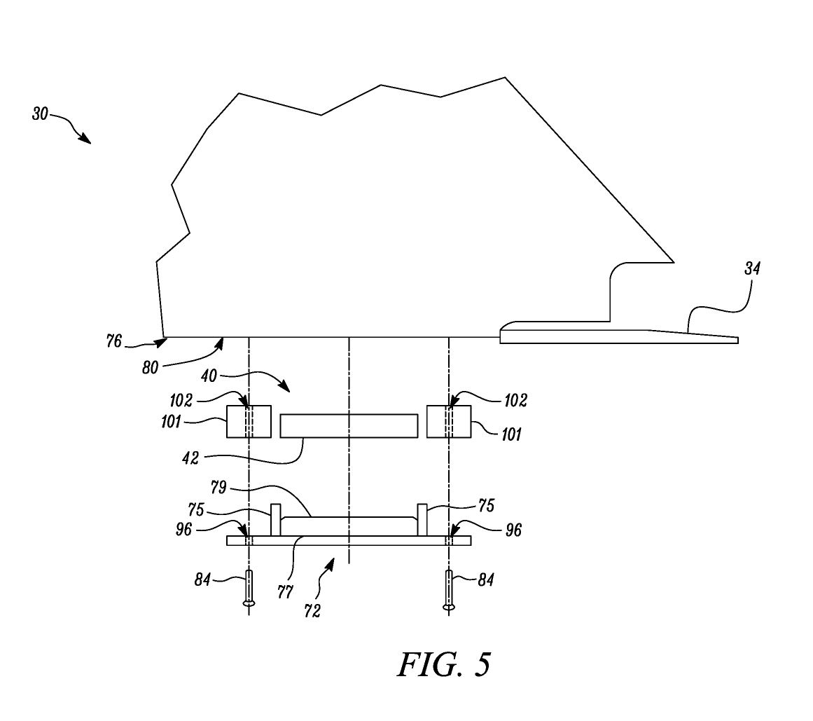

Referring to FIGS. 4 and 5, the second cover plate 72 is coupled to a second section 76 of the bucket 30. The second section 76 is opposite to the first section 54 (see FIG. 2). More particularly, the second cover plate 72 is coupled to the floor 78 of the bucket 30. As shown in the accompanying figure, the second cover plate 72 is coupled to a lower surface 80 of the floor 78. Alternatively, the second cover plate 72 may be coupled to an upper surface 82 of the floor 78.

The second cover plate 72 is removably coupled to the bucket 30 using mechanical fasteners 84. More particularly, the through holes 96 in the second cover plate 72, the through holes 102 defined in the spacers 101, and through holes (not shown) defined in the floor 78 are aligned to receive the mechanical fasteners 84 for coupling of the second cover plate 72 with the floor 78 of the bucket 30. In one example, a portion of the mechanical fasteners 84 may project upwards from the surface 82 of the floor 78. In such an example, nuts (not shown) may engage with the portion of the mechanical fasteners 84 that project upwards from the surface 82, for secure coupling of the second cover plate 72 with the floor 78.

In one example, the mechanical fasteners 84 may be threadably coupled to the floor 78 for attaching the second cover plate 72 with the floor 78. Thus, the mechanical fasteners 84 may embody any one of a bolt or a screw, without any limitations. Alternatively, the mechanical fasteners 84 may include weld studs. In such an example, the mechanical fasteners 84 may be welded to the floor 78 for coupling the second cover plate 72 with the floor 78 of the bucket 30. The second cover plate 72 may be coupled to the bucket 30 using another joining process, such as, brazing, soldering, etc., without any limitations.

Referring now to FIG. 2, the bucket 30 includes a first channel 86 and a second channel 88. Each of the pair of channels 86, 88 are provided on opposing sides of the bucket 30. In the illustrated example, the first and second channels 86, 88 are embodied as generally straight channels that allow routing of wires or cables therethrough. The first and second channels 86, 88 extend between the first compartment 52 and the second compartment 74. In the illustrated example, the first and second channels 86, 88 house the wires 50 that communicably couple the sensor module 40 with the control module 46. The first and second channels 86, 88 define a hollow space 89 for routing of the wires 50. The wires 50 may be received in any one of the first and second channels 86, 88. For explanatory purposes, a single wire 50 is shown to be enclosed in the first channel 86. Each of the first and second channels 86, 88 include an arcuate member 91, 94, respectively. The arcuate members 91, 94 are coupled to the bucket 30 in such a way that the hollow space 89 is formed between the respective arcuate member 91, 94 and the bucket 30. The arcuate members 91, 94 may be coupled to the bucket 30 by welding, brazing, soldering, etc. In one example, a top section and a bottom section of the arcuate members 91, 94 are welded to the base member 56 and the floor 78 of the bucket 30, respectively.

Further, the arcuate member 91 defines a first semi-circular opening 93 that provides an access route between the arcuate member 91 and the first compartment 52. The arcuate member 91 also defines a second semi-circular opening 95 that provides an access route between the arcuate member 91 and the sensor module 40. Thus, the wires 50 from the sensor module 40 are received in the first compartment 52 through the second semi-circular opening 95, the first channel 86, and the first semi-circular opening 93, respectively. Similarly, the arcuate member 94 also includes a first semi-circular opening (not shown) and a second semi-circular opening (not shown) similar to the first and second semi-circular openings 93, 95, respectively.

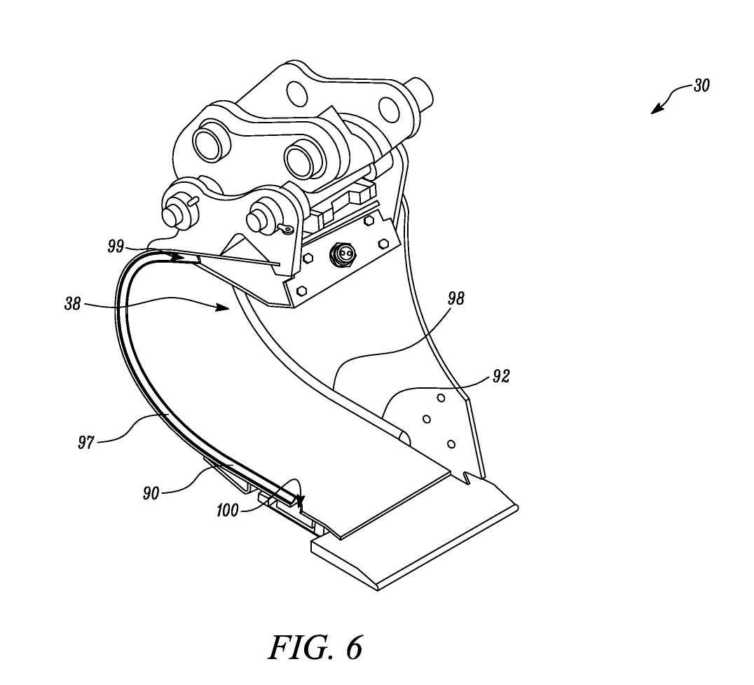

Further, the first and second channels 86, 88 may have a different shape, based on system requirements. Referring to FIG. 6, the first and second channels 90, 92 extending between the first compartment 52 and the second cover plate 72 include a curved shape corresponding to a contour of the bucket 30. More particularly, the first and second channels 90, 92 may follow a curvature that is defined by the bucket 30. The arcuate member 97 includes the first semi-circular opening 99 and the second semi-circular opening 100 similar to the first and second semi-circular openings 93, 95, respectively. Further, the arcuate member 98 also includes the first semi-circular opening (not shown) and the second semi-circular opening (not shown) similar to the first and second semi-circular openings 99, 100, respectively. It should be noted that the first and second channels 86, 88, 90, 92 may include any other shape and structure that allows routing of the wires 50 between the first compartment 52 and the second cover plate 72. Further, in one example, the bucket 30 may include a single channel instead of a pair of channels, without any limitations.

Further, the sensor module 40 of the RADAR system 38 mentioned above scans and penetrates the ground surface 12 proximate to the bucket 30. In the illustrated embodiment, the sensor module 40 makes use of RADAR technology to detect the presence of the object beneath the ground surface 12. When the sensor module 40 detects the presence of the object, the sensor module 40 generates the signal indicative of the presence of the object beneath the ground surface 12.

The material of each of the base member 56, the first cover plate 64, the second cover plate 72, the channels 86, 88, 90, 92 may be selected such that the material is resistant to a surrounding in which the bucket 30 is operating. Further, the material should be sturdy in operation as the components of the bucket 30 are subjected to high pressures during operation. In one example, each of the base member 56, the first cover plate 64, the second cover plate 72, the channels 86, 88, 90, 92 may be made of a metal or a polymer. In one example, each of the base member 56, the first cover plate 64, the second cover plate 72, the channels 86, 88, 90, 92 may be made of a steel, such as stainless steel, without any limitations.

### INDUSTRIAL APPLICABILITY

The present disclosure relates to the bucket 30 having the integrated RADAR system 38. The disclosure provides an easy mounting solution for the RADAR system components on buckets having spacial constraints. Further, integration of the components of the RADAR system 38 with the bucket 30 allows detection of the objects beneath the ground surface 12 in real time. The components of the RADAR system 38 are mounted on the bucket 30 in such a way that the components are enclosed and protected from the surrounding to avoid damage of the RADAR system components by dust, dirt, etc.

The first compartment 52 having the first cover plate 64 protects and encloses the control module 46 of the RADAR system 38 to protect the sensitive parts of the control module 46 from dust or dirt particles during machine operation. Further, the sensor module 40 may be coupled to the second section 76 of the bucket 30 in a removable manner. The second cover plate 72 having the sensor module 40 may be coupled to the lower or upper surface 80, 82 of the floor 78.

The bucket 30 also includes the channels 86, 88, 90, 92 to house the wires 50 that connect the sensor module 40 to the control module 46. The first and second channels 86, 88, 90, 92 receive and enclose the wires 50 of the RADAR system 38. Thus, the first and second channels 86, 88, 90, 92 protect the wires 50 from damage during operation of the machine 10, since the bucket 30 is generally exposed to excavated materials, dirt, dust, and other foreign particles that may damage the wires 50. In one example, as shown in FIG. 2, the channels 86, 88 may be embodied as straight channels extending between the first compartment 52 and the second cover plate 72 to provide easy routing of the wires 50. Alternatively, a different route, such as that shown in FIG. 6, may be used to connect the first compartment 52 and the second cover plate 72, based on system requirements, without any limitations.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A bucket associated with a machine, the bucket having an integrated RADAR system, the bucket comprising:
a first compartment provided at a first section of the bucket, the first compartment defining a cavity, wherein a control module of the RADAR system is mounted within the cavity of the first compartment;
a second compartment provided at a second section of the bucket, wherein the second section is opposite to the first section, wherein a sensor module of the RADAR system is mounted within the second compartment, the sensor module configured to scan and penetrate a ground surface proximate to the bucket; and
a channel extending between the first compartment and the second compartment, the channel adapted to house wires that communicably couple the sensor module with the control module.

2. The bucket of claim 1, wherein the first compartment further includes:
a first cover plate adapted to enclose the cavity, the first cover plate defining an aperture to receive an electrical connector of the RADAR system therethrough.

3. The bucket of claim 1, wherein a second cover plate is adapted to form the second compartment.

4. The bucket of claim 3, wherein the second cover plate is coupled to a floor of the bucket.

5. The bucket of claim 4, wherein the second cover plate is mechanically coupled to the floor of the bucket by at least one of mechanical fasteners and welding.

6. The bucket of claim 1, wherein the bucket includes a pair of channels extending between the first compartment and the second compartment, each of the pair of channels provided on opposing sides of the bucket.

7. The bucket of claim 1, wherein the channel extends vertically between the first and second compartments.

8. The bucket of claim 1, wherein the channel has a curved shape corresponding to a contour of the bucket.

9. A machine comprising:
a machine body; and
a bucket pivotably coupled to the machine body, the bucket having an integrated RADAR system, the bucket comprising:
a first compartment provided at a first section of the bucket, the first compartment defining a cavity, wherein a control module of the RADAR system is mounted within the cavity of the first compartment;
a second compartment provided at a second section of the bucket, wherein the second section is opposite to the first section wherein a sensor module of the RADAR system is mounted within the second compartment, the sensor module configured to scan and penetrate a ground surface proximate to the bucket; and
a channel extending between the first compartment and the second compartment, the channel adapted to house wires that communicably couple the sensor module with the control module.

10. The machine of claim 9, wherein the first compartment further includes:
a first cover plate adapted to enclose the cavity, the first cover plate defining an aperture to receive an electrical connector of the RADAR system therethrough.

11. The machine of claim 9, wherein a second cover plate is adapted to form the second compartment.

12. The machine of claim 11, wherein the second cover plate is coupled to a floor of the bucket.

13. The machine of claim 9, wherein the bucket includes a pair of channels extending between the first compartment and the second compartment, each of the pair of channels provided on opposing sides of the bucket.

14. The machine of claim 9, wherein the channel extends vertically between the first and second compartments.

15. The machine of claim 9, wherein the channel has a curved shape corresponding to a contour of the bucket.

16. A ground penetration system for a machine, the ground penetration system comprising:
a RADAR system including a control module and a sensor module; and
a bucket adapted to perform a digging operation of the machine, the bucket including:
a first compartment provided at a first section of the bucket, the first compartment defining a cavity;
a second compartment provided at a second section of the bucket, wherein the second section is opposite to the first section; and
a channel extending between the first compartment and the second compartment,
wherein the control module and the sensor module of the RADAR system are positioned within the first and second compartments of the bucket, respectively, and are electrically connected to each other by electrical wires housed within the channel for scanning and penetrating a ground surface proximate to the bucket.

17. The integrated RADAR system of claim 16, wherein the first compartment further includes:
a first cover plate adapted to enclose the cavity, the first cover plate defining an aperture to receive an electrical connector of the RADAR system therethrough.

18. The integrated RADAR system of claim 16, wherein a second cover plate is adapted to form the second compartment.

19. The integrated RADAR system of claim 18, wherein the second cover plate is coupled to a floor of the bucket.

20. The integrated RADAR system of claim 16, wherein the bucket includes a pair of channels extending between the first compartment and the second compartment, each of the pair of channels provided on opposing sides of the bucket.
